(19) United States
(12) Patent Application Publication
(10) Pub. No.: US 2026/0194708 A1
(43) Pub. Date: Jul. 9, 2026

(54) OPTICAL DEVICE AND METHOD OF MAKING SAME, AR GLASSES, AND VR GLASSES

(71) Applicant: SAE Magnetics (H.K,) Ltd., Hong Kong (CN)

(72) Inventors: Seiichi TAKAYAMA, Hong Kong (CN); Ryuji FUJII, Hong Kong (CN)

(21) Appl. No.: 19/293,391

(22) Filed: Aug. 7, 2025

(30) Foreign Application Priority Data
Jan. 7, 2025 (CN) 202510024709.3

(51) Int. Cl. G02B 6/12; G02B 6/13

(52) U.S. Cl. CPC G02B 6/12004; G02B 6/13; G02B 2006/12121; G02B 2006/12123

(57) ABSTRACT

The disclosure provides an optical device, a method of making the same, and optical glasses comprising the optical device. The optical device comprises an optical waveguide structure and a plurality of emitting elements. The optical waveguide structure is provided with a plurality of optical waveguide channels; The plurality of emitting elements are disposed on top of the optical waveguide structure and are connected and fixed to the optical waveguide structure in such a manner that the plurality of emitting elements are supported by the optical waveguide structure. The optical device does not need to additionally provide the substrate (i.e., the submount) for the emitting elements, thereby saving the space and cost for providing the substrate and thus allowing for a reduction in the total volume and the preparation cost of the optical device compared to the conventional optical device.

### TECHNICAL FIELD

The present disclosure relates to the field of optical display technology, more particularly to an optical device and a method of making the same, AR glasses, and VR glasses.

### BACKGROUND

Virtual Reality (VR for short) is a technology which utilizes computer techniques and hardware devices to give users a feel of a virtual environment engaging senses such as sight, sound, touch, and smell. Augmented Reality (AR for short) is a technology which overlays virtual information (such as images, sounds, videos, etc.) onto the real world to enhance users' experience of the real world.

In related technologies, AR and VR devices typically comprise two main parts: the optical engine and the optical system. Due to the characteristics of thin and lightweight of optical waveguides, the optical waveguide technology has been applied to AR and VR devices and has allowed a phased breakthrough in terms of the size and weight of the AR and VR devices, thereby making AR and VR glasses expected as future wearable devices.

Users have raised requirements for the AR and VR glasses, which serve as wearable devices, to be lightweight and compact. Thus, an extremely compact optical engine for the AR and VR glasses is desired, to allow for a reduction in the size and weight of the AR and VR glasses, thereby facilitating long-term and comfortable wearing by users. The optical device utilized by existing optical engines is provided with RGB laser diode units (LDU), each generally consisting of a laser diode chip (LD chip) and a submount, and the RGB laser diode units are bonded on a side surface of a planar waveguide. In the structure of such optical device, the LD chip and the submount, the LDU, and the planar waveguide all need bonding processes which consume materials. Furthermore, the size of such optical device can hardly be reduced further, which is detrimental to the lightweighting of the optical engine.

### SUMMARY

It is an object of the disclosure to provide an optical device and a method of making the same, AR glasses, and VR glasses. It may change the connection structure between the LD chip and the optical waveguide, thereby achieving a reduction in the size of the optical device and addressing the problem of existing optical device's size being difficult to further decreased.

In order to achieve the aforementioned object, an aspect of the disclosure provides a technical solution as follows.

An optical device, comprising:
an optical waveguide structure, the optical waveguide structure being provided with a plurality of optical waveguide channels; and
a plurality of emitting elements, all of the plurality of emitting elements being configured for emitting light beams, and the light beams emitted by the emitting elements each respectively enter corresponding one of the optical waveguide channels;
wherein the plurality of emitting elements are disposed on top of the optical waveguide structure and are connected and fixed to the optical waveguide structure in such a manner that the plurality of emitting elements are supported by the optical waveguide structure.

The above technical solution has advantages as follows. By directly bonding the emitting elements on the top of the optical waveguide structure and supporting the emitting elements by the optical waveguide structure, the optical device does not need to additionally provide a substrate (i.e., a submount) for the emitting elements, thereby saving the space for mounting the substrate and thus allowing for a reduction in the total volume of the optical device compared to the conventional optical device. Furthermore, the optical device can also save the cost for the material of the substrate and the cost for bonding the emitting elements and the substrate, thereby lowering the preparation cost of the optical device.

In an implementation, the top of the optical waveguide structure may be provided with a plurality of cavities, the cavities may be recessed towards a bottom of the optical waveguide structure and respectively provided with an opening extending through the top of the optical waveguide structure; each of the optical waveguide channels may be in communication with corresponding one of the cavities, and each of the emitting elements may be disposed into the corresponding one of the cavities through the opening, and may be connected and fixed to the corresponding one of the cavities.

The above technical solution has advantages as follows. As the optical waveguide structure is provided with a plurality of cavities, such that the emitting elements can be bonded within the cavities. In this way, the emitting elements can be at least partially accommodated inside the optical waveguide structure. Hence, the total volume of the optical device can be further decreased, reaching the order of 10% of the conventional optical device.

In an implementation, the plurality of optical waveguide channels have inlet ports at an equal height.

The above technical solution has advantages as follows. In the optical waveguide structure typically prepared by the WF process, the inlet and outlet ports of one optical waveguide channel are typically located at the same height, and the inlet ports of the plurality of optical waveguide channels are located at the same height, facilitating the convergence of the output ports of the plurality of optical waveguide channels to a single one and thus facilitating the preparation of the optical device.

In an implementation, each of the cavities may have a depth matched with a height of an emission port of the corresponding one of the emitting elements, such that the emission port of each of the emitting elements is aligned with the inlet port of the corresponding one of the optical waveguide channels.

The above technical solution has advantages as follows. The depth of each of the cavities matches with the height of the emission port of the corresponding one of the emitting elements mounted in the cavity, thereby allowing the emitting elements of different sizes to fit with respective optical waveguide channels and ensuring the emitting elements of different sizes to emit light beams into respective optical waveguide channels.

In an implementation, the depths of all of the cavities may be equal, and heights of the emission ports of the plurality of emitting elements may be equal.

The above technical solution has advantages as follows. As the plurality of cavities have a unified depth dimension, and the emission ports of the plurality of emitting elements have a unified height dimension, the preparation process of the optical device can be simplified.

In an implementation, a waveguide layer may be provided on top of the optical waveguide structure, the plurality of optical waveguide channels may be provided in the waveguide layer, the plurality of emitting elements may be disposed beside the waveguide layer, and an emission port of each of the emitting elements may be aligned with an inlet port of the corresponding one of the optical waveguide channels.

The above technical solution has advantages as follows. As the emitting elements are disposed beside the waveguide layer, it does not need to prepare cavities in the waveguide layer of the optical device, thereby achieving a simpler preparation process of the waveguide layer and facilitating better preparation of the optical waveguide structure.

In an implementation, a platform block may be provided at bottom of each one of the emitting elements and may be connected with the optical waveguide structure, to enable adjustment of a distance between the emission port of the one of the emitting elements and the inlet port of the corresponding one of the optical waveguide channels in such a manner that the emission port of the one of the emitting elements aligns with the inlet port of the corresponding one of the optical waveguide channels.

The above technical solution has advantages as follows. By providing the platform blocks, the distances between the emitting elements and respective inlet ports of respective optical waveguide channels can be adjusted to enable the emitting elements of different dimensions to match with respective optical waveguide channels and ensure the emitting elements of different dimensions to emit light beams into respective optical waveguide channels.

In an implementation, the optical waveguide structure may be provided with a substrate and a plurality of dielectric layers, and the plurality of dielectric layers may be formed on top of the substrate and arranged along a height direction of the substrate.

The above technical solution has advantages as follows. The optical waveguide structure may be fabricated by using WF technique. The plurality of dielectric layers are formed on the substrate by depositing. The plurality of dielectric layers are arranged along the height direction of the substrate, such that the plurality of dielectric layers can respectively achieve various functions, such as the waveguide layer, the covering layer, etc.

In an implementation, the plurality of optical waveguide channels may have outlet ports at an equal height; and
the optical waveguide channels may have inlet ports at an equal height as their outlet ports, such that the plurality of optical waveguide channels are formed in a same dielectric layer; or
at least one of the optical waveguide channels may have an inlet port at a height not equal to its outlet port, such that the at least one of the optical waveguide channels extends through the plurality of dielectric layers.

The above technical solution has advantages as follows. As the outlet ports of the plurality of optical waveguide channels are arranged to have an equal height, it facilitates the convergence of the output ports of the plurality of optical waveguide channels. The inlet ports of the optical waveguide channels can have the same or different heights as their outlet ports, to meet the requirements of optical paths for various products.

In an implementation, a plurality of electrical connecting components may be further provided, the plurality of electrical connecting components may be electrically connected with an external device to obtain electrical energy, and the plurality of electrical connecting components may be respectively connected with respective emitting elements, to allow respective emitting elements to obtain electrical energy for emitting light beams.

The above technical solution has advantages as follows. As the electrical connecting components are connected with respective emitting elements to supply electrical energy needed for operation of the emitting elements, it ensures that the emitting elements can emit light beams.

In an implementation, the emitting elements may be laser diodes.

The above technical solution has advantages as follows. The laser diodes have the advantages of small size and light weight. Thus, utilizing laser diodes as the emitting elements of the optical device is beneficial for controlling the volume and weight of the optical device.

In an implementation, each of the emitting elements may comprise a P-type semiconductor region and an N-type semiconductor region which are oppositely arranged, wherein
the P-type semiconductor region may be arranged to face the bottom of the optical waveguide structure and connected with the optical waveguide structure; or, the N-type semiconductor region may be arranged to face the bottom of the optical waveguide structure and connected with the optical waveguide structure.

The above technical solution has advantages as follows. The laser diode is typically provided with a P-type semiconductor region and an N-type semiconductor region which are oppositely arranged. The emitting element may select the P-type semiconductor region or the N-type semiconductor region for connecting the optical waveguide structure, so as to enable the optical device to meet requirements for different products.

In an implementation, each of the electrical connecting components may comprise a first connector and a second connector, wherein
the P-type semiconductor region in connection with the optical waveguide structure may be electrically connected with the first connector, and the N-type semiconductor region may be electrically connected with the second connector; or,
the N-type semiconductor region in connection with the optical waveguide structure may be electrically connected with the first connector, and the P-type semiconductor region may be electrically connected with the second connector.

The above technical solution has advantages as follows. The first connector and the second connector can be respectively electrically connected with the P-type semiconductor region and the N-type semiconductor region, such that the electrical connecting component can be connected with positive and negative terminals of the emitting element, thereby forming a current path together with the emitting element.

In an implementation, the first connector may comprise a first connecting portion and a second connecting portion which are connected with each other, the first connecting portion may be disposed on an outer side of the top of the optical waveguide structure and electrically connected with the external device; and the second connecting portion may be arranged inside the optical waveguide structure and extend to the corresponding one of the emitting elements to electrically connect with the corresponding one of the emitting elements.

The above technical solution has advantages as follows. As the second connecting portion is internally arranged within the optical waveguide structure, the electrical connecting component can be connected with the emitting element arranged in the cavity more conveniently. Furthermore, as the first connecting portion is externally arranged on top of the optical waveguide structure, the external device can be connected with the electrical connecting component more conveniently.

In an implementation, the second connector is disposed on an outer side of the top of the optical waveguide structure and electrically connected with the external device.

The above technical solution has advantages as follows. As the second connector is externally disposed on top of the optical waveguide structure, the external device can be connected with the electrical connecting component more conveniently.

In an implementation, the second connector has one end directly connected with the external device and the other end directly connected with corresponding one of the emitting elements.

The above technical solution has advantages as follows. As the second connector is directly connected to the external device, it eliminates the need for providing connection pads on the optical waveguide structure. Thus, the electrical connecting component has more simple structure, and a more lightweight optical device can be provided.

In an implementation, the P-type semiconductor regions or the N-type semiconductor regions, which are directly connected with the second connectors, are commonly grounded.

The above technical solution has advantages as follows. The plurality of emitting elements commonly grounded are beneficial to stabilize the voltage and current of the emitting element during operation and enhance the circuit stability of the optical device. Moreover, during operation of the emitting element, heat will be generated. The plurality of emitting elements commonly grounded can serve as a good heat conductor, to conduct the heat generated during operation of the emitting elements, thereby enhancing the service lives of the emitting elements.

In an implementation, a connecting layer is provided between each of the emitting elements and the optical waveguide structure, and the emitting elements are disposed on the connecting layers, respectively, such that the emitting elements are connected and fixed to the cavities.

The above technical solution has advantages as follows. As the connecting layer is provided between the emitting element and the connecting layer, the connecting layers can be thermally melted by the bonding lasers to achieve connection and fixation between the emitting elements and the cavities.

In an implementation, melting points of the connecting layers are lower than that of the optical waveguide structure, and the connecting layers are thermally meltable to bond the emitting elements with the cavities.

The above technical solution has advantages as follows. As the melting point of the connecting layer is lower than that of the optical waveguide structure, it prevents the optical waveguide structure from being damaged by the bonding laser when bonding the emitting element with the optical waveguide structure by the bonding laser.

In an implementation, each of the connecting layers has a melting point different from the other connecting layers; or, on a cross section perpendicular to a height direction of the optical waveguide structure, each of the connecting layers has a cross-sectional area different from the others connecting layers.

The above technical solution has advantages as follows. The melting points of every connecting layer are not equal, or the cross-sectional areas of every connecting layer are not equal, such that every connecting layer absorbs different amounts of total heat, thereby preventing the heat generated by the subsequently-bonded emitting element from affecting the stability of the connecting layer of the previously bonded emitting element.

Based on the aforementioned optical device, the disclosure further provides a method of making the aforementioned optical device, comprising steps as follows.

Providing the optical waveguide structure with the plurality of optical waveguide channels;

Providing the plurality of connecting layers on top of the optical waveguide structure, with adjacent connecting layers being spaced apart by a first predetermined distance;

Correspondingly disposing the emitting elements on the connecting layers, respectively;

Thermally fusing the connecting layers and bonding the connecting layers with respective emitting elements and the optical waveguide structure.

The above technical solution has advantages as follows. By disposing the emitting elements on the connecting layers and bonding the emitting elements and the optical waveguide structure correspondingly by the connecting layers, the emitting elements can be directly bonded on top of the optical waveguide structure, and the emitting elements can be supported by the optical waveguide structure. In this way, the optical device does not need to additionally provide the substrate (i.e., the submount) for the emitting elements, thereby saving the space for mounting the substrate and thus allowing for a reduction in the total volume of the optical device compared to the conventional optical device. Furthermore, the optical device can also save the cost for the material of the substrate and the cost for bonding the emitting elements and the substrate, thereby lowering the preparation cost of the optical device.

In an implementation, the thermally fusing the connecting layers further comprises steps as follows.

Obtaining cross-sectional areas of cross sections, perpendicular to a height direction of the optical waveguide structure, of the plurality of emitting elements;

Based on the cross-sectional areas of the plurality of emitting elements, sequentially bonding the emitting elements with the optical waveguide structure according to a descending order of the cross-sectional areas.

The above technical solution has advantages as follows. When bonding the emitting elements and the optical waveguide structure according to a descending order of the cross-sectional areas of the emitting elements, the heat generated by the connecting layer that is subsequently thermally melted is less than the heat required to melt the connecting layer that is currently thermally melted. Hence, when the successor emitting element is irradiated by laser, the connecting layer that is currently irradiated will not be thermally melted and will remain bonded to the corresponding emitting element and the optical waveguide structure.

In an implementation, the providing the plurality of connecting layers on top of the optical waveguide structure further comprises steps as follows.

Sorting the emitting elements based on the cross-sectional areas of the plurality of emitting elements, to put the emitting elements with a same cross-sectional area in a same order;

Providing the plurality of connecting layers on top of the optical waveguide structure, with the plurality of connecting layers corresponding to the emitting elements put in the same order; and

After bonding the corresponding emitting elements with the optical waveguide structure, further comprising a step as follows.

Providing a plurality of connecting layers of a followed order on top of the optical waveguide structure.

The above technical solution has advantages as follows. By sorting the emitting elements in such a manner that those having a same cross-sectional area are at a same order level, the preparation method facilitates the unified processing of the emitting elements of the same specification, and thus facilitates the preparation of large quantities of the optical device.

In an implementation, it further comprising steps as follows.

Obtaining cross-sectional areas of cross sections, perpendicular to a height direction of the optical waveguide structure, of the plurality of emitting elements;

According to a descending order of the cross-sectional areas based on the cross-sectional areas of the plurality of emitting elements, sequentially arranging the connecting layers according to a descending order of melting points;

Sequentially bonding the emitting elements with the optical waveguide structure according to the descending order of melting points.

The above technical solution has advantages as follows. The melting point of the connecting layer is directly proportional to the heat generated by laser welding. Determining the welding sequence of the connecting layers based on the specifications and dimensions of the emitting elements or the areas occupied by the emitting elements in combination with the melting points of the connecting layers, can ensure that the heat generated by the connecting layer that is subsequently thermally melted is less than the heat required to melt the connecting layer that is currently thermally melted.

In an implementation, the providing a plurality of connecting layers on top of the optical waveguide structure further comprises steps as follows.

Sorting the plurality of connecting layers based on the melting points thereof, to put the connecting layers with a same melting point in a same order;

Providing the plurality of connecting layers on top of the optical waveguide structure, with the plurality of connecting layers having a same melting point; and

After bonding the corresponding emitting elements with the optical waveguide structure, further comprising a step as follows.

Providing connecting layers of a followed order on top of the optical waveguide structure.

The above technical solution has advantages as follows. By sorting the emitting elements in such a manner that those having a same cross-sectional area are at a same order level and providing the connecting layers with different temperatures of melting points for the emitting elements put in different order levels, the present preparation method facilitates the unified processing of the emitting elements of the same specification and thus facilitates the preparation of large quantities of the optical device.

Based on the aforementioned optical device, the disclosure further provides optical glasses comprising any one of the aforementioned optical devices and have the advantages of the aforementioned optical device, wherein the optical glasses are AR glasses or VR glasses.

Compared with prior arts, the embodiments of the disclosure provide the optical device and the method of making the same, the AR glasses, and the VR glasses, which have advantages as follows. By directly bonding the emitting elements of the optical device on top of the optical waveguide structure, the emitting elements can be supported by the optical waveguide structure. In this way, the optical device does not need to additionally provide the substrate (i.e., the submount) for the emitting elements, thereby saving the space for mounting the substrate and thus allowing for a reduction in the total volume of the optical device compared to the conventional optical device. Furthermore, the optical device can also save the cost for the material of the substrate and the cost for bonding the emitting elements and the substrate, thereby lowering the preparation cost of the optical device.

Furthermore, as the optical waveguide structure of the optical device is provided with a plurality of cavities, the emitting elements can be bonded within the cavities. In this way, the emitting elements can be at least partially accommodated inside the optical waveguide structure. Hence, the total volume of the optical device can be further decreased, reaching the order of 10% of the conventional optical device. Moreover, by coordinating the depth of each cavity and the height of the emission port of the emitting element mounted within the cavity, the emitting elements of different sizes can be matched with corresponding optical waveguide channels, thereby ensuring that the beams from the emitting elements of different dimensions can correspondingly enter the optical waveguide channels.

Furthermore, in the preparation method of the optical device, the welding may be performed according to the descending order of the cross-sectional areas of the emitting elements, or alternatively, the welding sequence of the connecting layers may be determined based on the specifications and dimensions of the emitting elements or the areas occupied by the emitting elements, in combination with the melting points of the connecting layers. It ensures that the heat generated by the connecting layer that is subsequently thermally melted is less than the heat required to melt the connecting layer that is currently thermally melted.

### BRIEF DESCRIPTION OF THE DRAWINGS

FIG. 1 is a schematic view of an optical device according to an embodiment of the disclosure;

FIG. 2 is a schematic view illustrating a first implementation, in which an emitting element is provided on top of an optical waveguide structure, according to an embodiment of the disclosure;

FIG. 3 is a schematic view which illustrates a cavity of the structure as shown in FIG. 2;

FIG. 4 is a schematic view which illustrates a connection between the emitting element and an electrical connecting component of the structure as shown in FIG. 2;

FIG. 5 is a further schematic view which illustrates a connection between the emitting element and an electrical connecting component of the structure as shown in FIG. 2;

FIG. 6 is a schematic view which illustrates the structure as shown in FIG. 2, with a first connector being in corporation with the optical waveguide structure;

FIG. 7 is a schematic view which illustrates an emitting element fitting with a cavity, according to an embodiment of the disclosure;

FIG. 8 is a further schematic view which illustrates an emitting element fitting with a cavity, according to an embodiment of the disclosure;

FIG. 9 is a schematic view which illustrates optical waveguide channels according to an embodiment of the disclosure;

FIG. 10 is a schematic view which illustrates optical waveguide channels extending through a plurality of dielectric layers according to an embodiment of the disclosure;

FIG. 11 is a schematic view illustrating a second implementation, in which an emitting element is provided on top of an optical waveguide structure, according to an embodiment of the disclosure;

FIG. 12 is a schematical flow chart which illustrates a first example of preparing an optical device according to an embodiment;

FIG. 13 is a schematical flow chart which illustrates a second example of preparing an optical device according to an embodiment;

FIG. 14 illustrates an optical device used for welding according to the schematical flow chart as shown in FIG. 13.

FIG. 15 is a schematical flow chart which illustrates a third example of preparing an optical device according to an embodiment;

FIG. 16 is a schematical flow chart which illustrates a fourth example of preparing an optical device according to an embodiment;

FIG. 17 is a schematical flow chart which illustrates a fifth example of preparing an optical device according to an embodiment;

In the drawings: 100. optical device; 1. optical waveguide structure; 1a. optical waveguide channels; 10a. inlet port; 11a. outlet port; 1b. cavity; 10b. opening; 1c. waveguide layer; 1d. substrate; 1e. dielectric layers; 2. emitting elements; 2a. emission ports; 2b. P-type semiconductor region; 2c. N-type semiconductor region; 3. platform block; 4. electrical connecting component; 4a. first connector; 40a. first connecting portion; 41a. second connecting portion; 4b. second connector; 5. connecting layer; 6. external device.

### DETAILED DESCRIPTION OF ILLUSTRATED EMBODIMENTS

The particular implementations of the application will be further described below in detail in conjunction with the drawings and embodiments. The following embodiments are intended for illustration of the application and are not intended to limit the scope of the application.

It should be understood that, in the description of the present application, an element, which is referred to as being fixed or disposed on a further element, may be directly or indirectly provided on the further element, and an element, which is referred to as being connected with a further element, may be directly or indirectly connected with the further element. The terms “mount”, “join” and “connect” are intended to have meanings commonly understood in a broad sense. For example, they may refer to fixedly connect, or detachably connect, or integrally connect; or mechanically connect, or electrically connect; or directly connect, or indirectly connect via an intermedium, or internally communicate between two components, or interact between two components. The particular meanings of these terms used in the present application may be understood by those skilled in the art in accordance with specific conditions.

It should be understood that, for convenience of description and for the purpose of simplicity, the terms such as “height”, “upper”, “lower”, “vertical”, “horizontal”, “top”, “bottom”, “inner”, and “outer” as used in the description of the application refer to orientation and position relationships as shown in the drawings. They are not intended to indicate or hint a limitation in terms of specific orientation or configuration and operation with specific orientation to the described device or element, and should not be regarded as a limitation to the present application.

It should be understood that, the terms “first” and “second” used in the description of the invention are used for purposes of illustration and are not intended to indicate or imply relative importance or hint the number of features referred to. Hence, features defined by the terms “first” or “second” are intended to indicate or hint one or more of such features.

### Embodiments

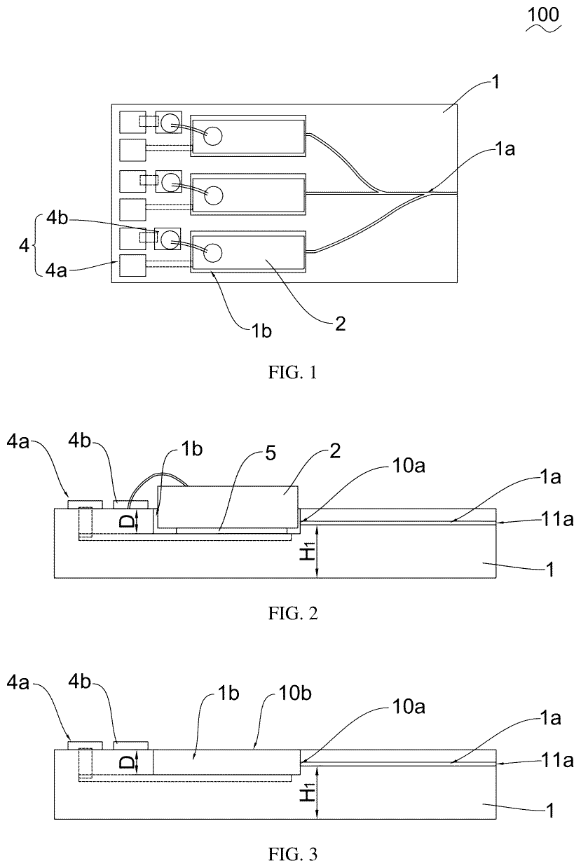

Referring to FIGS. 1-17, in an embodiment of the disclosure, an optical device 100 is provided, which comprises an optical waveguide structure 1 and a plurality of emitting elements 2, wherein the optical waveguide structure 1 is provided with a plurality of optical waveguide channels 1a; all of the plurality of emitting elements 2 are configured to emit light beams, the light beams emitted by the emitting elements 2 respectively correspondingly enter the optical waveguide channels 1a; and the plurality of emitting elements 2 are disposed on top of the optical waveguide structure 1 and are connected and fixed to the optical waveguide structure 1 in such a manner that the plurality of emitting elements 2 are supported by the optical waveguide structure 1.

It should be noted that the emitting elements 2 of the optical device 100 in the embodiment refer to electronic components, such as laser diodes (LDs) and light emitting diodes (LEDs), which can generate light beams when excited by the electrons. Generally, each of the emitting elements 2 is provided with an emission port 2a, which is an opening allowing for emission of light beams.

The optical waveguide structure 1 is generally provided with a substrate 1d, such as a glass base. Nowadays, the optical waveguide structure 1 is typically fabricated by using WF technique (Buried rib waveguide fabrication process). It forms a plurality of dielectric layers 1e by sequentially depositing materials on the substrate 1d. The plurality of dielectric layers 1e are formed on top of the substrate 1d and arranged along the height direction of the substrate 1d, thus the waveguide layer 1c can be formed on the substrate 1d. Depending on the optical signals to be transmitted, different materials can be used to prepare the waveguide layer 1c for the optical waveguide structure 1. Alternatively, different coupling structures, such as the geometric optical waveguide and the diffractive optical waveguide, can be configured for the waveguide layer 1c.

It should be noted that the process of the WF technique typically comprises: depositing a waveguide core material onto the surface of the silicon substrate, patterning the waveguide core material through photolithography, and then etching unwanted areas of the waveguide core material. Herein, the unwanted areas, which are etched, are cladding regions. After that, lifting off the photoresist pattern, and depositing a material in the cladding regions, to form the waveguide core structure and the cladding structure.

The optical waveguide channels 1a are typically formed in the waveguide layer 1c. Typically, the plurality of optical waveguide channels 1a are provided in the waveguide layer 1c depending on the number of the incident beams of light. Based on the optical waveguide structure 1, the light beams emitted by means of the emitting element 2 are coupled into the optical waveguide channels 1a and transmitted to a target site, for example a position in front of a user's eye, according to the principle of total internal reflection. During such process, the optical waveguide structure 1 serves to transmit the image. In a general case, however, it does not alter the image itself.

It should be appreciated that, the optical device 100 in the embodiment provides the emitting elements 2 on top of the optical waveguide structure 1, thereby supporting the emitting elements 2 by the optical waveguide structure 1 and meeting the requirement for the coordination between the emitting elements 2 and the optical waveguide channels 1a. Hence, the optical device 100 does not need to additionally provide a submount for the emitting elements 2. Consequently, it can not only simplify the mounting process of the emitting elements 2, but also save the space that the optical device 100 occupies and thus allow for a reduction in the weight and size of the optical device 100.

It should be noted that, in the embodiment, one side of the optical waveguide structure 1, on which the substrate 1d is disposed, is defined as the bottom, and the opposite side is defined as the top. The arrangement of the emitting elements 2 on top of the optical waveguide structure 1 may have a variety of implementations. For example, particularly in a first implementation of providing emitting elements 2 on top of the optical waveguide structure 1, the top of the optical waveguide structure 1 may be provided with a plurality of cavities 1b, the cavities 1b may be recessed towards the bottom of the optical waveguide structure 1 and respectively provided with an opening 10b extending through the top of the optical waveguide structure 1; Each of the optical waveguide channels 1a may be in communication with a corresponding cavity 1b, and each of the emitting elements 2 may be disposed into the corresponding cavity 1b through the corresponding opening 10b, and connected and fixed to the corresponding cavity 1b.

Referring to FIGS. 2-3, in an example of the aforementioned first implementation, RGB emitting elements 2 may be used for fabrication of the optical device 100. Herein, one of the emitting elements 2 is configured to emit red beams, one of the emitting elements 2 is configured to emit green beams, and one of the emitting elements 2 is configured to emit blue beams. The optical waveguide structure 1 is accordingly provided with three cavities 1b, each of which is in communication with corresponding one of the optical waveguide channels 1a. The RGB emitting elements 2 are mounted in the three cavities 1b, respectively, such that the light beams emitted by The RGB emitting elements 2 can correspondingly enter the optical waveguide channels 1a. Apparently, the emitting elements 2 of the optical device 100 are not limited to those for emitting beams of a single color. According to requirements for the optical device 100, the RGB emitting elements 2 may be replaced with other optical elements for emitting beams of other colors or composite beams.

Concerning the depths of the cavities 1b inside the optical waveguide structure 1, there are no rigid requirements. Generally speaking, the depths of the cavities 1b should conform to the specifications of the emitting elements 2. The RGB emitting elements 2 can be directly bonded in the areas of the cavities 1b of the optical waveguide structure 1, in such a manner that the opening of the emission port 2a of each of the emitting elements 2 is aligned with the corresponding one of the optical waveguide channels 1a which is in communication with the corresponding one of the cavities 1b, thereby allowing the light beams emitted by the emitting elements 2 to enter respective optical waveguide channels 1a from respective cavities 1b.

As the cavities 1b are provided inside the optical waveguide structure 1, the emitting elements 2 mounted inside the cavities 1b can be completely or partially positioned inside the optical waveguide structure 1. Hence, the outline dimensions of the optical device 100 can be further reduced. In comparison with the conventional optical device which has an outline size (length×width×height) of 3 mm×3 mm×1 mm, the optical device 100 of the invention can have an outline size (length× width×height) decreased to 2 mm×1 mm×0.5 mm, reaching the order of 10% of the conventional optical device.

The optical device 100 in the embodiment may utilize the planar waveguide, which has the advantage of a small size, as the optical waveguide structure 1. In addition, the light beams emitted by the plurality of emitting elements 2 are generally combined in the optical waveguide channels 1a, allowing the optical device 100 to make an output waveguide at one port. It requires that the heights H1 of the inlet ports 10a of the plurality of optical waveguide channels 1a are equal. Furthermore, since the emitting elements 2 of different models usually have different specifications and sizes, it further requires an adjustment for the depths D of each of the cavities 1b of the optical device 100, to enable the depth D of each of the cavities 1b to match with the height H2 of the emission port 2a of the corresponding one of the emitting elements 2, thereby allowing the emitting elements 2 of different sizes to fit with respective optical waveguide channels 1a and ensuring the emitting elements 2 of different sizes to emit light beams into respective optical waveguide channels 1a.

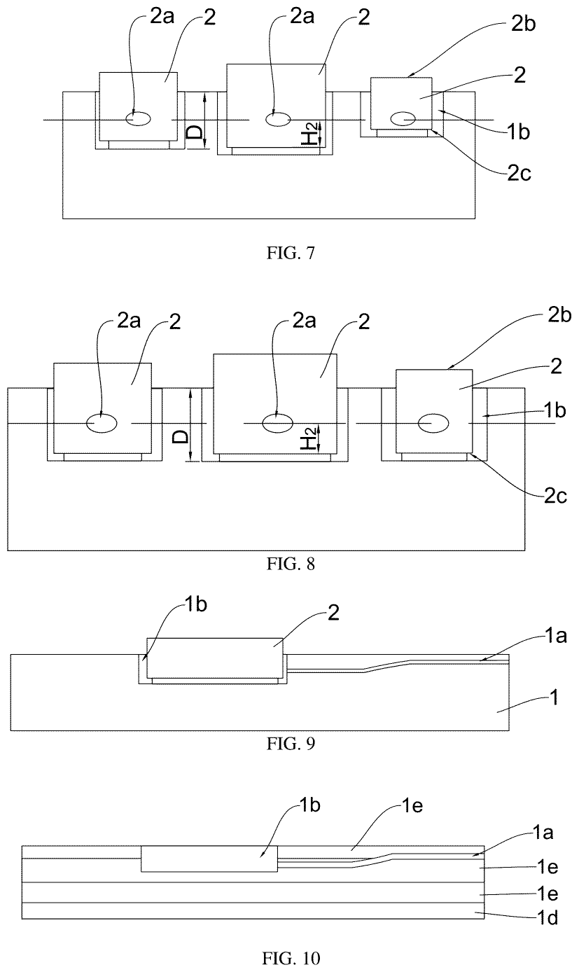

The heights H2 of the emission ports 2a of the emitting elements 2 refer to the vertical distances from respective emission port 2a to the bottom of corresponding emitting element 2. Referring to FIG. 7, in a case that the heights H1 of the inlet ports 10a of the plurality of optical waveguide channels 1a are equal, the distances between the emission ports 2a of the emitting elements 2 of different specifications and the inlet ports 10a of the optical waveguide channels 1a vary. By providing different depths D for the cavities 1b, the optical device 100 enables the emission port 2a of each of the emitting elements 2 to align with the inlet port 10a of the corresponding optical waveguide channel 1a. Apparently, referring to FIG. 8, in a case that the heights H2 of the emission ports 2a of the plurality of emitting elements 2 of the optical device 100 are equal, the depths D of the cavities 1b can be equal. It can be achieved by customizing the emitting elements 2. In this way, the preparation process of the optical device 100 can be simplified.

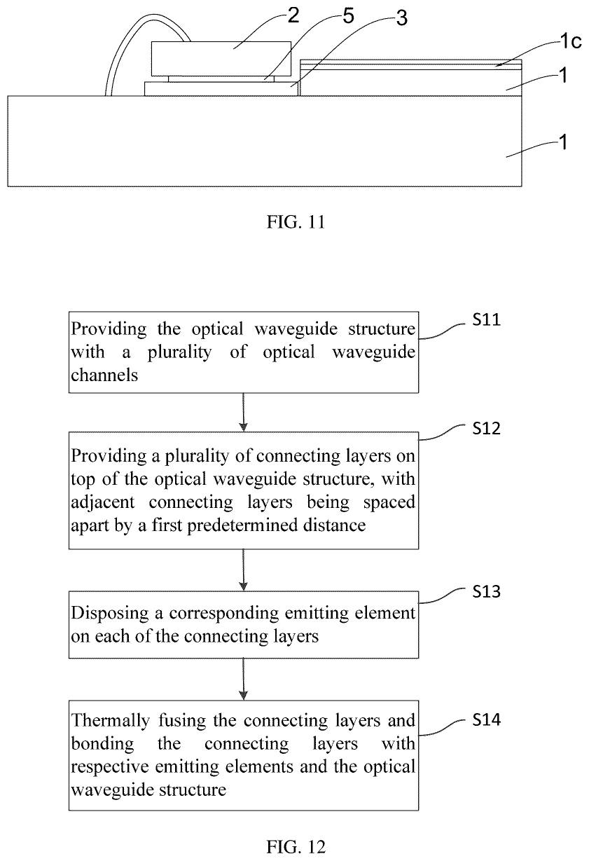

The waveguide layer 1c is provided on top of the optical waveguide structure 1. During preparation of the waveguide layer 1c, the position of the waveguide layer 1c on the substrate 1d can be adjusted such that the waveguide layer 1c occupies a part of the area of the substrate 1d rather than covers the top of the substrate 1d. In this way, it does not need to prepare cavities 1b in the waveguide layer 1c of the optical device 100, thereby achieving a simpler preparation process of the waveguide layer 1c and facilitating better preparation of the optical waveguide structure 1. Referring to FIG. 11, in a second implementation of providing emitting elements 2 on top of the optical waveguide structure 1, the plurality of optical waveguide channels 1a may be also provided in the waveguide layer 1c. The plurality of emitting elements 2 are disposed beside the waveguide layer 1c, and the emission port 2a of each of the emitting elements 2 is aligned with the inlet port 10a of the corresponding optical waveguide channel 1a.

It should be appreciated that, in the aforementioned second implementation, the emitting elements 2 are located beside the waveguide layer 1c rather than the waveguide structure. In comparison with the conventional optical device, the emitting elements 2 according to the second implementation are also supported by the optical waveguide structure 1. It eliminates the need for any additional submount for the emitting elements 2, and shares the advantages of the optical device 100 according to the first implementation.

The emitting elements 2 of different models mostly have different specifications and sizes. To enable the emission port 2a of each of the emitting elements 2 to align with the inlet port 10a of the corresponding one of the optical waveguide channels 1a, a platform block 3 may be provided at the bottom of each of the emitting elements 2. The platform block 3 may be connected to the optical waveguide structure 1 and serve for the adjustment of the distance between the emission port 2a of respective emitting element 2 and the inlet port 10a of the corresponding optical waveguide channel 1a, thereby allowing the emission port 2a of each of the emitting elements 2 to align with the inlet port 10a of the corresponding optical waveguide channel 1a.

It should be noted that, typically, a plurality of dielectric layer 1e are deposited on the substrate 1d of the optical waveguide structure 1, and the waveguide layer 1c is merely one of the plurality of dielectric layers 1e. The arrangement of the emitting elements 2 disposed beside the waveguide layer 1c and connected with the optical waveguide structure 1 may refer to the emitting elements 2 connected to the substrate 1d of the optical waveguide structure 1, or alternatively, the emitting elements 2 connected to a further dielectric layer 1e of the optical waveguide structure 1. Similarly, the platform block 3 may be connected to either the substrate 1d of the optical waveguide structure 1 or a further dielectric layer 1e of the optical waveguide structure 1.

It should be appreciated that, in the optical waveguide structure 1 prepared by the WF process, the optical waveguide channels 1a are generally located at the same height, namely that the outlet ports 11a of the plurality of optical waveguide channels 1a have an equal height. Moreover, the inlet ports 10a of the optical waveguide channels 1a have the same height as their outlet ports 11a, such that the plurality of optical waveguide channels 1a are formed in a same dielectric layer 1e, facilitating the convergence of the output ports of the plurality of optical waveguide channels 1a to a single output waveguide. Apparently, referring to FIGS. 9-10, the optical device 100 may be made, by adjusting process parameters, in such a manner that an inlet port 10a of at least one of the optical waveguide channels 1a has a height not equal to that of its outlet port 11a, enabling the said optical waveguide channel 1a to extend through more than one dielectric layer 1e, to meet the requirements of optical paths for various products.

The optical device 100 is further provided with a plurality of electrical connecting components 4. The plurality of electrical connecting components 4 are electrically connected with an external device 6, to obtain electrical energy. The plurality of electrical connecting components 4 are respectively connected with corresponding emitting elements 2, such that each of the emitting elements 2 can obtain electrical energy to emit light beams. Typically, the number of the electrical connecting components 4 is the same as the number of the emitting elements 2, with each one of the electrical connecting components 4 being electrically connected with the respective one of the emitting elements 2 to supply electrical energy thereto. Apparently, the number of the electrical connecting components 4 may also be different from the number of the emitting elements 2, with one electrical connecting component 4 being connected to the plurality of emitting elements 2.

In AR glasses and VR glasses, now the emitting elements 2 typically utilize laser diodes that have the advantages of a small size and light weight. Utilizing a laser diode as the emitting element 2 of the optical device 100 is beneficial for controlling the volume and weight of the optical device 100. Referring to FIGS. 7-8, the emitting element 2, which utilizes a laser diode, generally comprises a P-type semiconductor region 2b and an N-type semiconductor region 2c which are oppositely arranged. Herein, as long as the optical device 100 can meet requirements for different products, the P-type semiconductor region 2b and the N-type semiconductor region 2c are not limited in terms of their position arrangements. For example, the emitting element 2 may be arranged in such a manner that the P-type semiconductor region 2b faces the bottom of the optical waveguide structure 1 and connected with the optical waveguide structure 1; or alternatively, the emitting element 2 may be arranged in such a manner that the N-type semiconductor region 2c faces the bottom of the optical waveguide structure 1 and connected with the optical waveguide structure 1.

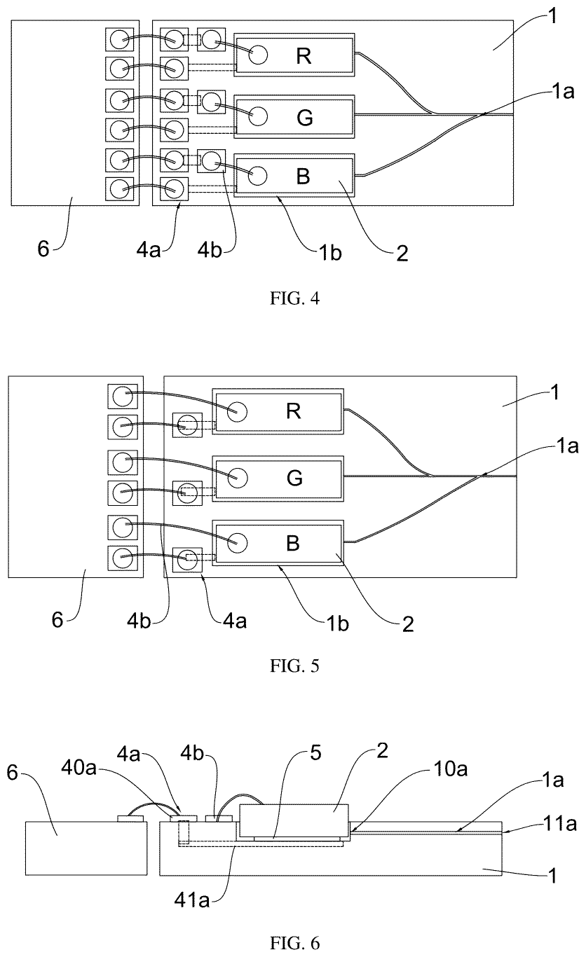

In order to allow the laser diode to conduct electricity, the electrical connecting component 4 may be provided with a first connector 4a and a second connector 4b. By connecting the first connector 4a and the second connector 4b with the positive and negative terminals of the laser diode, the electricity conduction of the laser diode can be achieved. Referring to FIG. 4, in an example of the embodiment, the first connector 4a and the second connector 4b are connection pads. Herein, in a case that the P-type semiconductor region 2b faces the bottom of the optical waveguide structure 1 and connected with the optical waveguide structure 1, the P-type semiconductor region 2b, which is connected with the optical waveguide structure 1, is electrically connected with the first connector 4a, and the N-type semiconductor region 2c is electrically connected with the second connector 4b; In a case that the N-type semiconductor region 2c faces the bottom of the optical waveguide structure 1 and connected with the optical waveguide structure 1, N-type semiconductor region 2c, which is connected with the optical waveguide structure 1, is electrically connected with the first connector 4a, and the P-type semiconductor region 2b is electrically connected with the second connector 4b.

The first connector 4a needs to connect to the bottom of the emitting element 2. However, the distance between the emitting element 2 and the optical waveguide structure 1 is too small, or even nonexistent, to allow an external wire to enter. Consequently, referring to FIGS. 4 and 6, the first connector 4a in an example of the embodiment may comprise a first connecting portion 40a and a second connecting portion 41a, which are connected with each other. The first connecting portion 40a is disposed on an outer side of the top of the optical waveguide structure 1 and electrically connected with the external device 6; The second connecting portion 41a is arranged inside the optical waveguide structure 1, extending to the emitting element 2 and being electrically connected with the emitting element 22. The first connecting portion 40a, which serving as an external connecting terminal, may be a connection pad. By the corporation between the first connecting portion 40a and the second connecting portion 41a which is arranged inside the optical waveguide structure 1, the external device 6 can be connected to the first connecting portion 40a and thus to the emitting element 2.

Referring to FIG. 4 which illustrates an example of the embodiment, the second connector 4b may be a connection pad. The second connector 4b may be disposed on an outer side of the top of the optical waveguide structure 1 and electrically connected with the emitting element 2 through a wire. Furthermore, the second connector 4b may be electrically connected with the external device 6 through a wire. Apparently, the quantity and size of the connection pad may be selected according to the specifications of the optical device 100 and the wires.

Referring to FIG. 5 which illustrates a further example of the embodiment, the second connector 4b may alternatively be a wire. In such a case, the second connector 4b may have one end directly connected with the external device 6 and the other end directly connected with the emitting element 2. In this way, as the emitting element 2 can be directly connected to the connection pad of the external device 6 via the second connector 4b, it can save on the number of connection pads, eliminating the need for providing excessive connection pads on the optical waveguide structure 1.

Furthermore, in the example of the configuration, the P-type semiconductor regions 2B or the N-type semiconductor regions 2C directly connected with the second connectors 4b can be commonly grounded. The plurality of emitting elements 2 commonly grounded are beneficial to stabilize the voltage and current of the emitting element 2 during operation and enhance the circuit stability of the optical device 100. Moreover, during operation of the emitting element 2, heat will be generated. The plurality of emitting elements 2 commonly grounded can serve as a good heat conductor, to conduct the heat generated during operation of the emitting elements 2, thereby enhancing the service lives of the emitting elements 2.

Referring to FIG. 6, in an example of the embodiment, in order to ensure the connection and fixation between the emitting element 2 and the optical waveguide structure 1, a connecting layer 5 may be provided between each of the emitting elements 2 and the optical waveguide structure 1, and each of the emitting elements 2 may be disposed on the connecting layer 5 and connected and fixed to the respective cavity 1b. The connecting layer 5 may be an adhesive or a solder. For example, the emitting element 2 can be connected to the optical waveguide structure 1 by the laser bonding process. In such laser bonding process, the bonding laser is typically directed and emitted towards the optical waveguide structure 1 from the bottom of the optical waveguide structure 1, to heat and melt the solder between the emitting element 2 and the optical waveguide structure. Consequently, in the laser bonding process, the connecting layer 5 is typically formed by thermally melting the solder. Apparently, it requires that the melting point of the connecting layer 5 is lower than that of the optical waveguide structure 1, thereby ensuring that the optical waveguide structure 1 can be kept un-melted when the connecting layer 5 is thermally melted to achieve the adhesion between the emitting element 2 and the cavity 1b.

It should be noted that the emitting element 2 utilized in the optical device 100 are of a very small size, and the plurality of emitting elements 2 are bonded individually. Taking the RGB emitting elements 2 for example, they are bonded one by one after position alignment, rather than being bonded simultaneously in a single adhesion step.

In the case that the RGB emitting elements 2 are bonded one by one, due to the small size of the emitting elements 2, the heat generated when the next emitting element 2 is bonded may be prone to transfer to the connecting layer 5 of the previously bonded emitting element 2 and affect the stability of the connecting layer 5 of the said previously bonded emitting element 2. It is conceivable that the amount of heat dissipated to the surrounding area by the connecting layer 5 would be affected by the total heat it absorbs, and the total heat it absorbs would be affected by the melting point and volume of the connecting layer 5. Hence, in one single optical device 100, the connecting layers 5 provided for the emitting elements 2 can be made to respectively absorb different amounts of total heat by varying the melting point or the volume of the connecting layers 5 provided for the emitting elements 2. For example, each of the connecting layers 5 may use different types of solders, to achieve unequal melting points of each of the connecting layers 5. Alternatively, on a cross section perpendicular to the height direction of the optical waveguide structure 1, each of the connecting layers 5 may have unequal sectional areas, such that each of the connecting layers 5 can have unequal volumes. Referring to FIG. 12 which is a schematical flow chart illustrating a first example of preparing the optical device 100 according to the embodiment, it particularly comprises the following steps from S11 to S14:
S11. Providing the optical waveguide structure 1 with a plurality of optical waveguide channels 1a;
S12. Providing a plurality of connecting layers 5 on top of the optical waveguide structure 1, with adjacent connecting layers 5 being spaced apart by a first predetermined distance;
S13. Disposing a corresponding emitting element 2 on each of the connecting layers 5;
S14. Thermally fusing the connecting layers 5 and bonding the connecting layers 5 with respective emitting elements 2 and the optical waveguide structure 1.

It is conceivable that, in the step S12, the connecting layers 5 arranged on top of the optical waveguide structure 1 refer to the materials that have not been thermally melted yet. These materials will be thermally melted in the step S14, to bond the corresponding emitting elements 2 with the optical waveguide structure 1 and form the connecting layers 5, respectively.

Based on the specification and dimension of the optical waveguide structure 1, the plurality of emitting elements 2 may be arranged in rows or columns. Thus, two adjacent connecting layers 5 may be either two adjacent connecting layers in a same row or two adjacent connecting layers in a same column. The first predetermined distance between two adjacent connecting layers 5 is compatible with the melting points and volumes of the connecting layers 5 to ensure that the two adjacent connecting layers 5 are not in close proximity and prevent the heat generated during thermal fusion of the two adjacent connecting layers 5 from causing positional shifts thereof.

Apparently, as the overall specification and dimension of the optical device 100 reaches 2 mm×1 mm×0.5 mm, the first predetermined distance between two adjacent connecting layers 5 is limited. Thus, during the processing and preparation of the optical device 100, it is necessary to take the total heat that each of the connecting layers 5 can absorb into account. Generally speaking, the laser power used for bonding is directly proportional to the volume of the connecting layer 5, and the total heat that the connecting layer 5 can absorb is also directly proportional to its volume. Thus, the laser power used for welding a connecting layer 5 with a larger volume is greater than the laser power used for welding a connecting layer 5 with a smaller volume. So, based on the sizes of the connecting layers 5, the larger connecting layers 5 is welded first and then the smaller ones. In such a case, the heat diffused by the subsequently-welded connecting layer 5 would not reach the total heat that the currently-welded connecting layer 5 can absorb. In this way, the heat diffused by the subsequently-welded connecting layer 5 would not make the currently-welded connecting layer 5 reach its melting point.

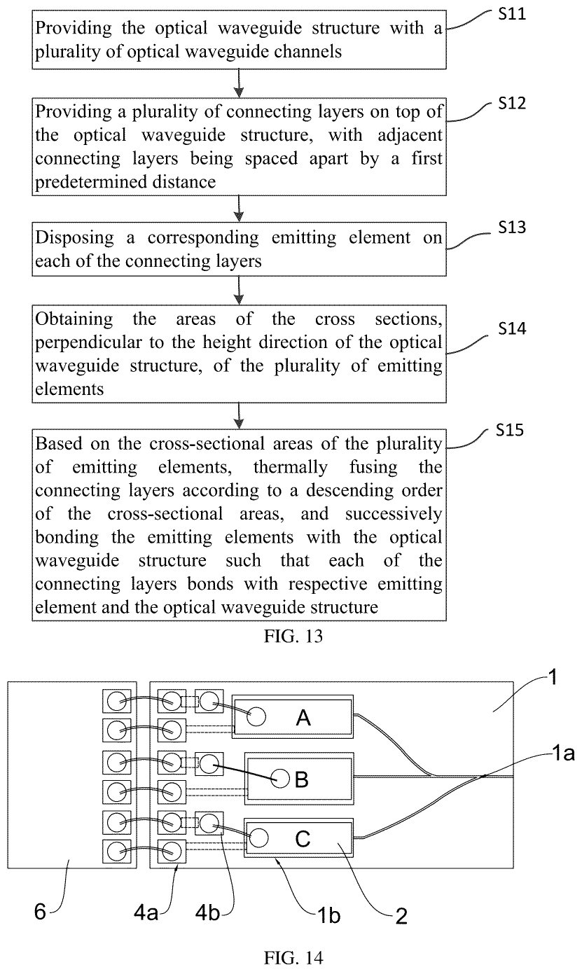

Concerning the volume of the connecting layer 5, the specification and dimension of the emitting element 2 connected therewith should be taken into account. Generally speaking, the larger the specification and dimension of the emitting element 2, the larger the volume of the connecting layer 5 associated therewith, and the more total heat the associated connecting layer 5 can absorb. Therefore, during preparation of the optical device 100 according to the embodiment, the welding sequence of the connecting layers 5 may be determined based on the specifications and dimensions of the emitting elements 2 or the areas occupied by the emitting elements 2. Referring to FIG. 13 which is a schematical flow chart illustrating a second example of preparing the optical device 100 according to the embodiment, it particularly comprises the following steps from S11 to S15:
S11. Providing the optical waveguide structure 1 with a plurality of optical waveguide channels 1a;
S12. Providing a plurality of connecting layers 5 on top of the optical waveguide structure 1, with adjacent connecting layers 5 being spaced apart by a first predetermined distance;
S13. Disposing a corresponding emitting element 2 on each of the connecting layers 5;
S14. Obtaining the area of the cross section, perpendicular to the height direction of the optical waveguide structure 1, of each of the plurality of emitting elements 2;
S15. Based on the cross-sectional areas of the plurality of emitting elements 2, thermally fusing the connecting layers 5 according to a descending order of the cross-sectional areas, and successively bonding the emitting elements 2 with the optical waveguide structure 1 in such a manner that each of the connecting layers 5 bonds with the corresponding emitting element 2 and the optical waveguide structure 1.

It should be appreciated that the step S14 is not limited to a specific sequence. The cross-sectional areas of the emitting elements 2 may be obtained before any of the steps S11 to S13, or even before the preparation of the optical device 100.

When bonding the emitting elements 2 and the optical waveguide structure 1 according to a descending order of the cross-sectional areas of the emitting elements 2, the first laser irradiation is performed on the emitting element 2 that has the largest size, then the second laser irradiation is performed on the emitting element 2 that has the second largest size, and so on for the other emitting elements 2. In such a case, the emitting element 2 that is subsequently irradiated by laser is smaller than the emitting element 2 that is currently irradiated by laser. Accordingly, the connecting layer 5 that is subsequently thermally melted is smaller than the connecting layer 5 that is currently thermally melted, and the heat generated by the connecting layer 5 that is subsequently thermally melted is less than the heat required to melt the connecting layer 5 that is currently thermally melted. Hence, when the successor emitting element 2 is irradiated by laser, the connecting layer 5 that is currently irradiated will not be thermally melted and will remain bonded to the corresponding emitting element 2 and the optical waveguide structure 1.

Furthermore, during laser irradiation, the irradiation duration and/or the emission power of the laser may be set according to the specifications of the emitting elements 2. For example, the emission power of the first laser irradiation is greater than that of the second laser irradiation, and the emission power of the second laser irradiation is greater than that of the third laser irradiation. In this way, it can be ensured that the heat generated by the connecting layer 5 that is subsequently thermally melted is less than the heat required to melt the connecting layer 5 that is currently thermally melted.

Specifically, to illustratively describe the preparation method according to the present implementation, a set of data for processing and preparing the optical device 100 is provided below. Please refer to Table 1.

TABLE 1

| Order | Size of LD Area | | Solder | Laser Power | Welding Duration |
|---|---|---|---|---|---|
| 1. B | L350 | μm | AuSn | 16 W | 800 msec |
| | W250 | μm | 80:20 wt % | | |
| 2. A | L500 | μm | AuSn | 14 W | 800 msec |
| | W150 | μm | 80:20 wt % | | |
| 3. C | L400 | μm | AuSn | 12 W | 800 msec |
| | W140 | μm | 80:20 wt % | | |

In the Table 1, the bonding laser is a continuous-wave laser with a wavelength of 920 μm and a beam diameter of 50 μm. Referring to FIG. 14 in conjunction with the Table 1, it can be seen that the laser diodes A, B, and C shown in FIG. 14 correspond to the emitting elements 2 in the present example. Furthermore, the area sizes of the three laser diodes A, B, and C satisfy the relationship as follows: the laser diode B>the laser diode A>the laser diode C. Thus, in the example shown in the Table 1, the first area to be welded is where the laser diode B is located, the second area to be welded is where the laser diode A is located, and the last area to be welded is where the laser diode C is located. Moreover, the laser power used for welding the laser diode B is 16W, the laser power used for welding the laser diode A is 14W, the laser power used for welding the laser diode C is 12W, and the laser powers used for welding the three laser diodes A, B, and C satisfy the relationship as follows: the laser diode B>the laser diode A>the laser diode C.

It is conceivable that the heat generated by laser welding is directly proportional to the magnitude of the laser power; namely, the higher the magnitude of the laser power, the more heat is generated by laser welding. Therefore, when the laser powers used for welding the three laser diodes A, B, and C satisfy the relationship of the laser diode B>the laser diode A>the laser diode C, the heat generated by welding the three laser diodes A, B, and C for a same welding duration will satisfy the relationship as follows: the laser diode B>the laser diode A>the laser diode C.

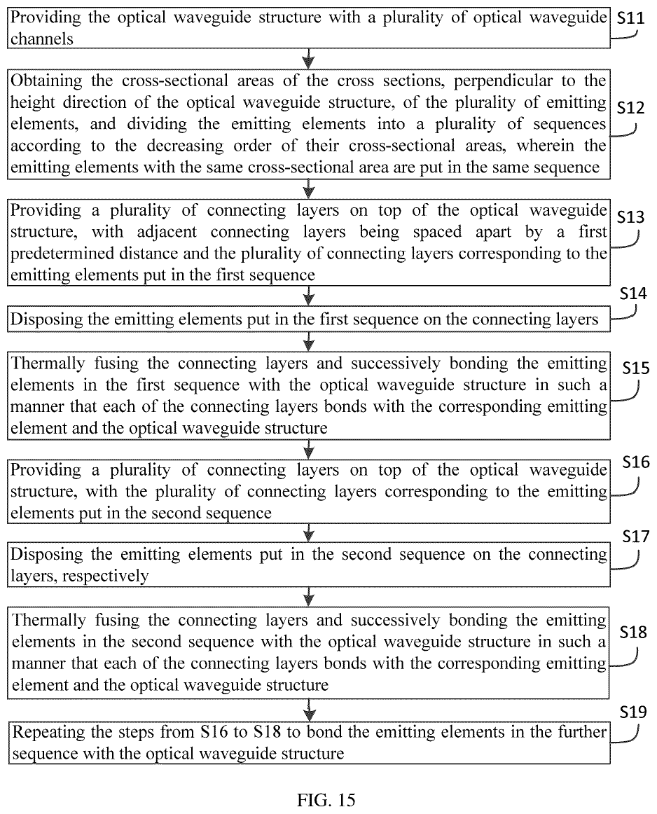

It should be appreciated that, in one single optical device 100, a plurality of emitting elements 2 may be provided. For example, taking the RGB emitting elements 2 as a group of emitting units, one single optical device 100 may be provided with a group of emitting units, or alternatively, provided with a plurality of groups of emitting units arranged in an array. In a case that one single optical device 100 is provided with a plurality of groups of emitting units, referring to FIG. 15 which is a schematical flow chart illustrating a third example of preparing the optical device 100 according to the embodiment, it particularly comprises the following steps from S11 to S19:
S11. Providing the optical waveguide structure 1 with a plurality of optical waveguide channels 1a;
S12. Obtaining the cross-sectional areas of the cross sections, perpendicular to the height direction of the optical waveguide structure 1, of the plurality of emitting elements 2, and dividing the emitting elements 2 into a plurality of sequences according to the decreasing order of their cross-sectional areas, wherein the emitting elements 2 with the same cross-sectional area are put in the same sequence; S13. Providing a plurality of connecting layers 5 on top of the optical waveguide structure 1, with adjacent connecting layers 5 being spaced apart by a first predetermined distance and the plurality of connecting layers 5 corresponding to the emitting elements 2 put in the first sequence;
S14. Disposing the emitting elements 2 put in the first sequence on the connecting layers 5, respectively;
S15. Thermally fusing the connecting layers 5 and successively bonding the emitting elements 2 in the first sequence with the optical waveguide structure 1 in such a manner that each of the connecting layers 5 bonds with the corresponding emitting element 2 and the optical waveguide structure 1;
S16. Providing a plurality of connecting layers 5 on top of the optical waveguide structure 1, with the plurality of connecting layers 5 corresponding to the emitting elements 2 put in the second sequence;
S17. Disposing the emitting elements 2 put in the second sequence on the connecting layers 5, respectively;
S18. Thermally fusing the connecting layers 5 and successively bonding the emitting elements 2 in the second sequence with the optical waveguide structure 1 in such a manner that each of the connecting layers 5 bonds with the corresponding emitting element 2 and the optical waveguide structure 1;
S19. Repeating the steps from S16 to S18 to bond the emitting elements 2 in the further sequence with the optical waveguide structure 1.

It should be noted that, alternatively, the step of obtaining the cross-sectional areas of the cross sections, perpendicular to the height direction of the optical waveguide structure 1, of the plurality of emitting elements 2, may be conducted in other sequence, for example, prior to the step S11.

Using the abovementioned preparation method, the emitting elements 2 of different specifications can be prepared in a sequence of the first sequence first, followed by the second sequence. By sorting the emitting elements 2 in such a manner that those having a same cross-sectional area are at a same order level, it facilitates the unified processing of the emitting elements 2 of the same specification, and thus facilitates the preparation of large quantities of the optical device 100 by using the present preparation method.

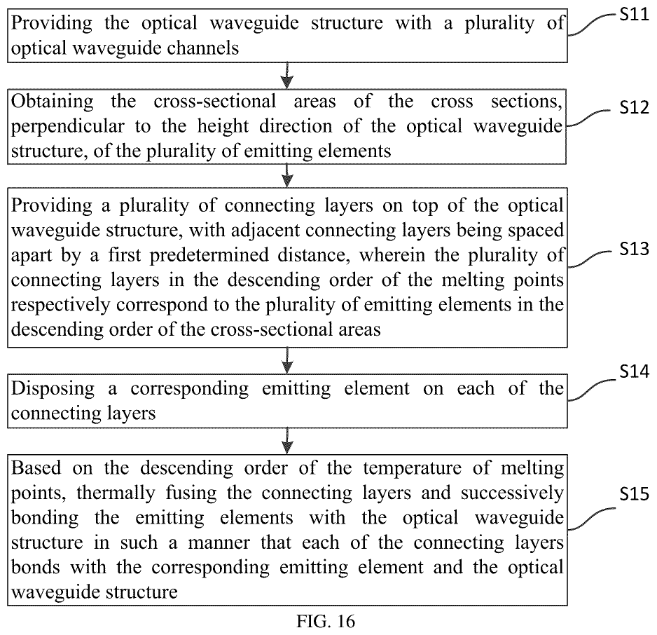

Apparently, during the preparation of the optical device 100 according to the embodiment, the welding sequence of the connecting layers 5 may also be determined based on the specifications and dimensions of the emitting elements 2 or the areas occupied by the emitting elements 2, in combination with the melting points of the connecting layers 5. Referring to FIG. 16 which is a schematical flow chart illustrating a fourth example of preparing the optical device 100 according to the embodiment, it particularly comprises the following steps from S11 to S15:
S11. Providing the optical waveguide structure 1 with a plurality of optical waveguide channels 1a;
S12. Obtaining the cross-sectional areas of the cross sections, perpendicular to the height direction of the optical waveguide structure 1, of the plurality of emitting elements 2;
S13. Providing a plurality of connecting layers 5 on top of the optical waveguide structure 1, with adjacent connecting layers 5 being spaced apart by a first predetermined distance, wherein the plurality of connecting layers in the descending order of the melting points respectively correspond to the plurality of emitting elements in the descending order of the cross-sectional areas;
S14. Disposing a corresponding emitting element 2 on each of the connecting layers 5;
S15. Based on the descending order of the temperature of melting points, thermally fusing the connecting layers 5 and successively bonding the emitting elements 2 with the optical waveguide structure 1 in such a manner that each of the connecting layers 5 bonds with the corresponding emitting element 2 and the optical waveguide structure 1.

It should be noted that, alternatively, the step of obtaining the cross-sectional areas of the cross sections, perpendicular to the height direction of the optical waveguide structure 1, of the plurality of emitting elements 2, may be conducted in other sequence, for example, prior to the step S11.

The melting points of the connecting layers 5 are directly proportional to the heat generated during laser welding; the higher the temperature of the melting point of the connecting layer 5, the more heat is produced by laser welding. The temperatures of the melting points of the connecting layers 5 can be varied by using different solders. For example, the first emitting element 2 to be welded may have the greatest cross-sectional area. It may use AuSn=80:20 wt % as the solder for bonding the connecting layers 5, and the melting temperature of such solder may be 280° C. The second emitting element 2 to be welded may have a cross-sectional area less than the first emitting element 2 and greater than the third emitting element 2. It may use SnAg as the solder for bonding the connecting layers 5, and the melting temperature of such solder may be 220° C. The third emitting element 2 to be welded may have the least cross-sectional area. It may use BiSn as the solder for bonding the connecting layers 5, and the melting temperature of such solder may be 180° C.

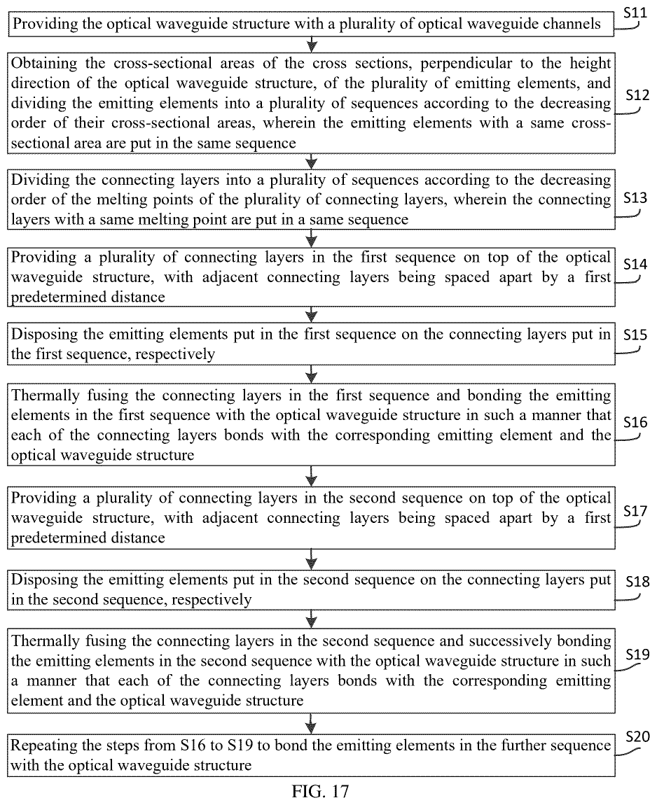

In a case that one single optical device 100 is provided with a plurality of groups of emitting units arranged, referring to FIG. 17 which is a schematical flow chart illustrating a fifth example of preparing the optical device 100 according to the embodiment, it particularly comprises the following steps from S11 to S20:
S11. Providing the optical waveguide structure 1 with a plurality of optical waveguide channels 1a;
S12. Obtaining the cross-sectional areas of the cross sections, perpendicular to the height direction of the optical waveguide structure 1, of the plurality of emitting elements 2, and dividing the emitting elements into a plurality of sequences according to the decreasing order of their cross-sectional areas, wherein the emitting elements 2 with a same cross-sectional area are put in the same sequence;
S13. Dividing the connecting layers 5 into a plurality of sequences according to the decreasing order of the melting points of the plurality of connecting layers, wherein the connecting layers 5 with a same melting point are put in a same sequence;
S14. Providing a plurality of connecting layers 5 in the first sequence on top of the optical waveguide structure 1, with adjacent connecting layers 5 being spaced apart by a first predetermined distance;
S15. Disposing the emitting elements 2 put in the first sequence on the connecting layers 5 put in the first sequence, respectively;
S16. Thermally fusing the connecting layers 5 in the first sequence and bonding the emitting elements 2 in the first sequence with the optical waveguide structure 1 in such a manner that each of the connecting layers 5 bonds with the corresponding emitting element 2 and the optical waveguide structure 1;
S17. Providing a plurality of connecting layers 5 in the second sequence on top of the optical waveguide structure 1, with adjacent connecting layers 5 being spaced apart by a first predetermined distance;
S18. Disposing the emitting elements 2 put in the second sequence on the connecting layers 5 put in the second sequence, respectively;
S19. Thermally fusing the connecting layers 5 in the second sequence and successively bonding the emitting elements 2 in the second sequence with the optical waveguide structure 1 in such a manner that each of the connecting layers 5 bonds with the corresponding emitting element 2 and the optical waveguide structure 1;
S20. Repeating the steps from S16 to S19 to bond the emitting elements 2 in the further sequence with the optical waveguide structure 1.

It should be noted that, alternatively, the step of obtaining the cross-sectional areas of the cross sections, perpendicular to the height direction of the optical waveguide structure 1, of the plurality of emitting elements 2, may be conducted in other sequence, for example, prior to the step S11.

By sorting the emitting elements 2 in such a manner that those having a same cross-sectional area are at a same order level and providing the connecting layers 5 with different temperatures of melting points for the emitting elements 2 put in different order levels, the present preparation method facilitates the unified processing of the emitting elements 2 of the same specification and thus facilitates the preparation of large quantities of the optical device 100.

In an embodiment of the disclosure, optical glasses are further provided, which comprise the aforementioned optical device 100 and have the advantages of the aforementioned optical device 100, wherein the optical glasses are AR glasses or VR glasses.

In conclusion, the embodiments of the disclosure provide the optical device 100 and the method of making the same, the AR glasses, and the VR glasses. By directly bonding the emitting elements 2 on the top of the optical waveguide structure 1, the emitting elements 2 can be supported by the optical waveguide structure 1. In this way, the optical device 100 does not need to additionally provide the substrate 1d (i.e., the submount) for the emitting elements 2, thereby saving the space for mounting the substrate and thus allowing for a reduction in the total volume of the optical device 100 compared to the conventional optical device. Furthermore, the optical device 100 can also save the cost for the material of the substrate 1d and the cost for bonding the emitting elements 2 and the substrate 1d, thereby lowering the preparation cost of the optical device 100.

Furthermore, as the optical waveguide structure 1 of the optical device 100 is provided with a plurality of cavities 1b, the emitting elements 2 can be bonded within the cavities 1b. In this way, the emitting elements 2 can be at least partially accommodated inside the optical waveguide structure 1. Hence, the total volume of the optical device 100 can be further decreased, reaching the order of 10% of the conventional optical device. Moreover, by coordinating the depth of each cavity 1b and the height of the emission port 2a of the emitting element 2 mounted within the cavity 1b, the emitting elements 2 of different sizes can be matched with corresponding optical waveguide channels 1a, thereby ensuring that the beams from the emitting elements of different dimensions can correspondingly enter the optical waveguide channels 1a.

Furthermore, in the preparation method of the optical device 100, the welding may be performed according to the descending order of the cross-sectional areas of the emitting elements 2, or alternatively, the welding sequence of the connecting layers 5 may be determined based on the specifications and dimensions of the emitting elements 2 or the areas occupied by the emitting elements 2, in combination with the melting points of the connecting layers 5. It ensures that the heat generated by the connecting layer 5 that is subsequently thermally melted is less than the heat required to melt the connecting layer 5 that is currently thermally melted.

All the above merely describe preferred implementations of the present application. It should be pointed out that those skilled in the art may obtain various modifications and equivalents included in the scope of the present application, without departing from the technical principle of the present application.

1. An optical device, comprising:
an optical waveguide structure, the optical waveguide structure being provided with a plurality of optical waveguide channels; and
a plurality of emitting elements, all of the plurality of emitting elements being configured for emitting light beams, and the light beams emitted by the emitting elements each respectively enter corresponding one of the optical waveguide channels;
wherein the plurality of emitting elements are disposed on top of the optical waveguide structure and are connected and fixed to the optical waveguide structure in such a manner that the plurality of emitting elements are supported by the optical waveguide structure.

2. The optical device according to claim 1, wherein a plurality of cavities are provided on top of the optical waveguide structure, each of the optical waveguide channels is in communication with corresponding one of the cavities, and each of the emitting elements is disposed into the corresponding one of the cavities.

3. The optical device according to claim 2, wherein the cavities are recessed towards a bottom of the optical waveguide structure and respectively provided with an opening extending through the top of the optical waveguide structure; and each of the emitting elements is disposed into the corresponding one of the cavities through the opening, and is connected and fixed to the corresponding one of the cavities.

4. The optical device according to claim 2, wherein the plurality of optical waveguide channels have inlet ports at an equal height, each of the cavities has a depth matched with a height of an emission port of the corresponding one of the emitting elements, such that the emission port of each of the emitting elements is aligned with the inlet port of the corresponding one of the optical waveguide channels, the depths of all of the cavities are equal, and heights of the emission ports of the plurality of emitting elements are equal.

5. The optical device according to claim 1, wherein a waveguide layer is provided on top of the optical waveguide structure, the plurality of optical waveguide channels are provided in the waveguide layer, the plurality of emitting elements are disposed beside the waveguide layer, and an emission port of each of the emitting elements is aligned with an inlet port of the corresponding one of the optical waveguide channels, a platform block is provided at bottom of each one of the emitting elements and is connected with the optical waveguide structure to enable an adjustment of a distance between the emission port of one of the emitting elements and the inlet port of the corresponding one of the optical waveguide channels in such a manner that the emission port of one of the emitting elements aligns with the inlet port of the corresponding one of the optical waveguide channels.

6. The optical device according to claim 1, wherein the optical waveguide structure is provided with a substrate and a plurality of dielectric layers, and the plurality of dielectric layers are formed on top of the substrate and arranged along a height direction of the substrate.

7. The optical device according to claim 6, wherein the plurality of optical waveguide channels have outlet ports at an equal height; and
the optical waveguide channels have inlet ports at an equal height as the outlet ports such that the plurality of optical waveguide channels are formed in a same dielectric layer; or
at least one of the optical waveguide channels has an inlet port at a height not equal to the outlet port thereof such that the at least one of the optical waveguide channels extends through two or more of the plurality of dielectric layers.

8. The optical device according to claim 1, wherein a plurality of electrical connecting components are further provided, the plurality of electrical connecting components are electrically connected with an external device to obtain electrical energy, and the plurality of electrical connecting components are respectively connected with corresponding one of the emitting elements, to allow the corresponding one of the emitting elements to obtain electrical energy for emitting light beams.

9. The optical device according to claim 8, wherein the emitting elements are laser diodes, each of the emitting elements comprises a P-type semiconductor region and an N-type semiconductor region which are oppositely arranged, wherein
the P-type semiconductor region is arranged to face a bottom of the optical waveguide structure and connected with the optical waveguide structure; or,
the N-type semiconductor region is arranged to face the bottom of the optical waveguide structure and connected with the optical waveguide structure.

10. The optical device according to claim 9, wherein each of the electrical connecting components comprises a first connector and a second connector, wherein
the P-type semiconductor region in connection with the optical waveguide structure is electrically connected with the first connector, and the N-type semiconductor region is electrically connected with the second connector; or,
the N-type semiconductor region in connection with the optical waveguide structure is electrically connected with the first connector, and the P-type semiconductor region is electrically connected with the second connector.

11. The optical device according to claim 10, wherein the first connector comprises a first connecting portion and a second connecting portion which are connected with each other, the first connecting portion is disposed on an outer side of the top of the optical waveguide structure and electrically connected with the external device; and the second connecting portion is arranged inside the optical waveguide structure and extends to the corresponding one of the emitting elements to electrically connect with the corresponding one of the emitting elements.

12. The optical device according to claim 10, wherein the second connector is disposed on an outer side of the top of the optical waveguide structure, the second connector has one end directly connected with the external device and the other end directly connected with corresponding one of the emitting elements, the P-type semiconductor regions or the N-type semiconductor regions, which are directly connected with the second connectors, are commonly grounded.

13. The optical device according to claim 2, wherein a connecting layer is provided between each of the emitting elements and the optical waveguide structure, and the emitting elements are disposed on the connecting layers, respectively, such that the emitting elements are connected and fixed to the cavities.

14. The optical device according to claim 13, wherein melting points of the connecting layers are lower than that of the optical waveguide structure, and the connecting layers are thermally meltable to bond the emitting elements with the cavities.

15. The optical device according to claim 13, wherein each of the connecting layers has a melting point different from the other connecting layers; or, on a cross section perpendicular to a height direction of the optical waveguide structure, each of the connecting layers has a sectional area different from the others connecting layers.

16. A method of making the optical device according to claim 1, comprising steps of:
providing the optical waveguide structure with the plurality of optical waveguide channels;
disposing the plurality of connecting layers on top of the optical waveguide structure, with adjacent connecting layers being spaced apart by a first predetermined distance;
correspondingly disposing the emitting elements on the connecting layers, respectively;
thermally fusing the connecting layers and bonding the connecting layers with the emitting elements, respectively, and with the optical waveguide structure.

17. A method according to claim 16, further comprising steps of:
obtaining cross-sectional areas of the cross sections, perpendicular to a height direction of the optical waveguide structure, of the plurality of emitting elements; and
wherein the step of thermally fusing the connecting layers and bonding the connecting layers comprises sequentially bonding the emitting elements with the optical waveguide structure according to a descending order of the cross-sectional areas of the plurality of emitting elements.

18. A method according to claim 17, the disposing the plurality of connecting layers on top of the optical waveguide structure, further comprises steps of:
dividing the emitting elements into a plurality of sequences according to the decreasing order of the cross-sectional areas of the plurality of emitting elements, in such a manner that the emitting elements having a same cross-sectional area are put in a same sequence;
disposing the plurality of connecting layers on top of the optical waveguide structure, with the plurality of connecting layers corresponding to the emitting elements which are put in the same sequence; and
after sequentially bonding the emitting elements with the optical waveguide structure, further comprising a step of:
disposing a plurality of connecting layers of a followed sequence on top of the optical waveguide structure.

19. A method according to claim 16, further comprising steps of:
obtaining cross-sectional areas of cross sections, perpendicular to a height direction of the optical waveguide structure, of the plurality of emitting elements;
wherein the step of disposing the plurality of connecting layers comprises disposing the plurality of connecting layers according to a descending order of melting points of the plurality of connecting layers;
wherein, in the step of correspondingly disposing the emitting elements on the connecting layers, the plurality of connecting layers in the descending order of the melting points respectively correspond to the plurality of emitting elements in the descending order of the cross-sectional areas; and
wherein the step of thermally fusing the connecting layers and bonding the connecting layers comprises sequentially bonding the emitting elements with the optical waveguide structure according to the descending order of the melting points.

20. A method according to claim 19, the disposing the plurality of connecting layers on top of the optical waveguide structure, further comprises steps of:
dividing the connecting layers into a plurality of sequences according to the decreasing order of the melting points of the plurality of connecting layers, in such a manner that the connecting layers with a same melting point are put in a same sequence;
disposing the plurality of connecting layers in the same sequence on top of the optical waveguide structure; and
after correspondingly bonding the emitting elements with the optical waveguide structure, further comprising a step of:
providing connecting layers of a followed sequence on top of the optical waveguide structure.

21. Optical glasses, comprising the optical device according to claim 1, wherein the optical glasses are AR glasses or VR glasses.
